(19) United States
(12) Patent Application Publication
(10) Pub. No.: US 2020/0334695 A1
(43) Pub. Date: Oct. 22, 2020

(54) USING ANONYMOUS CUSTOMER AND KNOWN CUSTOMER PURCHASING BEHAVIOR TO DEVELOP A MARKETING STRATEGY

(71) Applicant: Comenity LLC, Columbus, OH (US)

(72) Inventor: Mike SCHMIDT, Galena, OH (US)

(73) Assignee: Comenity LLC, Columbus, OH (US)

(21) Appl. No.: 16/752,384

(22) Filed: Jan. 24, 2020

Related U.S. Application Data
(60) Provisional application No. 62/837,014, filed on Apr. 22, 2019.

(51) Int. Cl. G06Q 30/02; G06F 16/906; G06F 16/9035

(52) U.S. Cl. CPC G06Q 30/0201; G06F 16/9035; G06F 16/906; G06Q 30/0204

(57) ABSTRACT

Methods and systems for enhancing customer purchasing behavior are disclosed. A transactional data evaluator receives a first set of aggregated customer transaction data, having no PII and a second set of aggregated customer transaction data, having PII. The transactional data evaluator uses the first set of aggregated customer transaction data to develop a plurality of customer profiles, compares the second set of aggregated customer transaction data with the plurality of customer profiles, and assigns each customer associated with the second set of aggregated customer transaction data to at least one of the plurality of customer profiles. A customer profile specific marketing strategy is then generated based on an evaluation of each customer associated with the second set of aggregated customer transaction data with respect to the assigned at least one of the plurality of customer profiles.

### CROSS-REFERENCE TO RELATED APPLICATIONS (PROVISONAL)

This application claims priority to and benefit of co-pending U.S. Provisional Patent Application No. 62/837,014 filed on Apr. 22, 2019, entitled “USING ANONYMOUS CUSTOMER AND KNOWN CUSTOMER PURCHASING BEHAVIOR TO DEVELOP A MARKETING STRATEGY” by Mike Schmidt, and assigned to the assignee of the present application, the disclosure of which is hereby incorporated by reference in its entirety.

### BACKGROUND

Presently, retailers and other third parties have to drive their understanding of competitive intelligence via market research such as asking customers where else they are shopping and how much they are spending. While, when asked by another party, customers are often open about where else they shop, they are also quite protective when the question changes to how much the customer spends while shopping elsewhere.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a system for using anonymous customer and known customer purchasing behavior to develop marketing strategies, in accordance with an embodiment.

FIG. 2 is a chart representing a partial data set in the consortium, the partial data set containing a plurality of profiles developed from the non-PII customer data, in accordance with an embodiment.

FIG. 3 is a chart representing a partial data set in the retailer database, the partial data set containing a plurality of identified customers sorted into different profiles, in accordance with an embodiment.

FIG. 4 is a chart representing a partial data set in the retailer database, the partial data set containing a number of marketing evaluations for the plurality of profiled matched identified customers, in accordance with an embodiment.

FIG. 5 is a chart representing a partial marketing matrix, the partial marketing matrix containing a real-time continuously updateable working marketing strategies for other customers as developed by the transactional data evaluator, in accordance with an embodiment.

FIG. 6 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “determining”, “collecting”, “combining”, “prescreening”, “developing”, “presenting”, “initiating”, “resetting”, or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In general, the term “retailer” is often used to define a specific shop (e.g., the Stanley shoe shop at 1 main street) while the term “brand” defines a collection of shops (e.g., Stanley shoe shops). In the following discussion, most, if not all, of the subject matter can be appropriately applied to either or both of a retailer and a brand. Thus, to avoid confusion and for purposes of clarity, unless it is specifically pointed out otherwise in the text, the term retailer will be understood to be used for both retailer and brand.

Importantly, the embodiments of the present invention, as will be described below, provide a capability to use anonymous customer purchasing behavior to develop and drive known customer purchasing behaviors. This system and method differs significantly from the conventional market research systems. In conventional approaches, customers are asked about where they shop and how much they spend. While customers may be open about where else they shop, they are often quite protective when the question changes to how much the customer spends while shopping.

Embodiments, as will be described and explained below in detail, provide a previously unknown procedure for using anonymous customer purchasing behavior to develop marketing strategies for known customers. For example, a consortium takes in data from a plurality of various information providers. The data provided by the various account is transactional data that is tied to a given customer, but which includes no personally identifiable information (PII) for the given customer. For example, the consortium receives a plurality of different credit account transactional data sets for a plurality of different anonymous customers. The credit account transactional data can be received from one or more of a plurality of information providers. The consortium sorts the credit account transactional data sets into different profiles based on one or more identified traits (e.g., customer age range, health profile, gender, and the like). The consortium then uses the different profiles to determine underlying purchasing behavior characteristics for each of the different profiles (e.g., males 30-45 years of age are x-times more likely to make a purchase at a sports store after receiving an offer for a y-percentage discount; females 18-25 years of age are x-times more likely to make a purchase at a store after receiving an offer for a free gift with a purchase; etc.). The consortium continues to develop/adjust/modify/tune, etc. the underlying purchasing behavior characteristics for each of the different profiles as additional credit account transactional data sets are received. The underlying purchasing behavior characteristics are then used to develop and direct purchasing behavior for known customers.

For example, the underlying purchasing behavior characteristics for the different developed profiles is provided to a transactional data evaluator that has access to known customer transaction data that includes PII (e.g., from a retailer database, credit account database, or the like). The transactional data evaluator will match the PII of the known customer transaction data with one or more of the different developed profiles. The transactional data evaluator will compare the transactions that occur in the PII customer transaction data with the underlying purchasing behavior characteristics for each of the different profiles.

Based on the comparison, the transactional data evaluator will then develop, adjust, optimize, or otherwise modify a marketing strategy for the known customer. In so doing, the anonymous customer purchasing behavior will be used to drive known customer's purchasing behavior.

Thus, embodiments of the present invention provide a streamlined system and method for using anonymous customer purchasing behavior to develop marketing strategies for known customers, which extends well beyond what was previously done and which provides a significant improvement to the development, adjustment, optimization, and modification of a customer's purchasing behavior. The solution further provides a novel system and method that can updated the underlying purchasing behavior characteristics for the different developed profiles on an hourly, daily, weekly, monthly, or otherwise selected schedule thereby allowing the retailer to evaluate/modify/start/stop offers/incentives/sales/rewards/and the like for a given known customer based on one or more of the developed profiles.

As will be described in detail, the various embodiments of the present invention do not merely implement conventional data acquisition processes on a computer. Instead, the various embodiments of the present invention, in part, provide a previously unknown procedure to drive known customer purchasing behaviors using anonymous customer transactional data. Hence, embodiments of the present invention provide a novel process which is necessarily rooted in computer technology to overcome a problem specifically arising in the realm of retailer customer development/attraction/marketing strategies/and the like.

Moreover, the embodiments do not recite a mathematical algorithm; nor do they recite a fundamental economic or longstanding commercial practice. Instead, they address a real-world solution to the ongoing problem of providing retailers with developed, adjusted, optimized, or otherwise modified marketing strategy for a known customer.

It should be appreciated that the obtaining or accessing of customer information conforms to applicable privacy laws (e.g., federal privacy laws, state privacy laws, etc.)

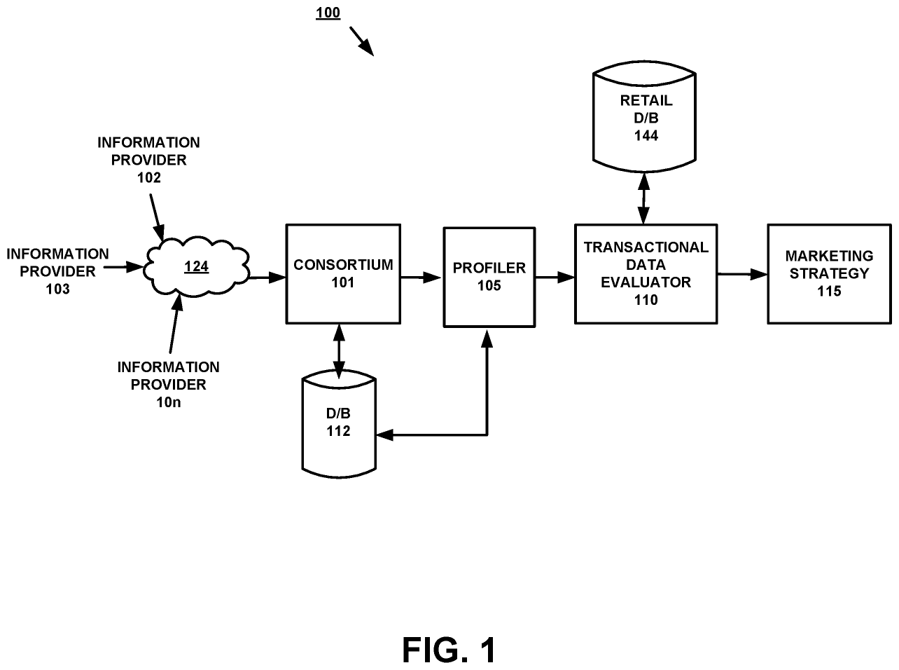

With reference now to FIG. 1, a system 100 for using anonymous customer purchasing behavior to develop marketing strategies for known customers is shown in accordance with an embodiment. System 100 includes information providers e.g., 102, 103, and 10n, network 124, consortium 101, consortium database 112, an anonymous customer profile developer (e.g., profiler 105), retailer database 144, transaction data evaluator 110, and marketing strategy 115. The components of system 100 can be co-located, distributed, or the like. Moreover, although there are a number of different components of system 100, the distinction is provided for purposes of clarity. In one embodiment, the components may be broken out as shown. In another embodiment, one or more of the components of system 100 can be combined, separated, co-located, remotely located, or the like.

In general, the one or more information providers e.g., 102, 103, and 10n can refer to any entity that maintains a database sufficient to provide the credit account transaction data (or customer transaction data). The information providers e.g., 102, 103, and 10n could be credit card provider(s) databases, historical purchase database(s), retail store purchase/customer database(s), credit bureau database(s), or any other entity that collects any customer transaction data.

In one embodiment, consortium 101 takes in transactional data from one or all of the plurality of various information providers e.g., 102, 103, and 10n. The data provided by the various information providers is a plurality of different transactional data sets for a plurality of different customers. However, the transactional data is organized such that a given customer's transactional data set is grouped together, but which includes no personally identifiable information (PII) for the given customer. For example, consortium 101 receives a plurality of different credit account transactional data sets for a plurality of different anonymous customers. The credit account transactional data can be received from one or more of a plurality of information providers. Consortium 101 sorts the credit account transactional data sets into different profiles based on one or more identified traits (e.g., customer age range, health profile, gender, and the like). Consortium 101 then uses the different profiles to determine underlying purchasing behavior characteristics for each of the different profiles (e.g., males 30-45 years of age are x-times more likely to make a purchase after receiving an offer for a y-percentage discount; females 18-25 years of age are x-times more likely to make a purchase after receiving an offer for a free gift with a purchase; etc.). Although, the customer transaction data will not include any PII, the customer transaction data can include profile identification information such as an age, a gender, a zip code, or the like. Moreover, the customer transactional data will include a plurality of purchase information such as groceries, auto, clothing, memberships, vices, etc.

In one embodiment, each customer transaction in the customer transaction data provided by the information providers to consortium 101 will include information such as, but not limited to (and, in one embodiment, differing at the per transaction level, the per account level, the per credit account provider level, or the like): a retailer, a transaction location (e.g., internet/in-store), a transaction type (plastic card, digital wallet, etc.), a price, a date, a SKU (or other item identifier), a size, a description of the item purchased, etc.

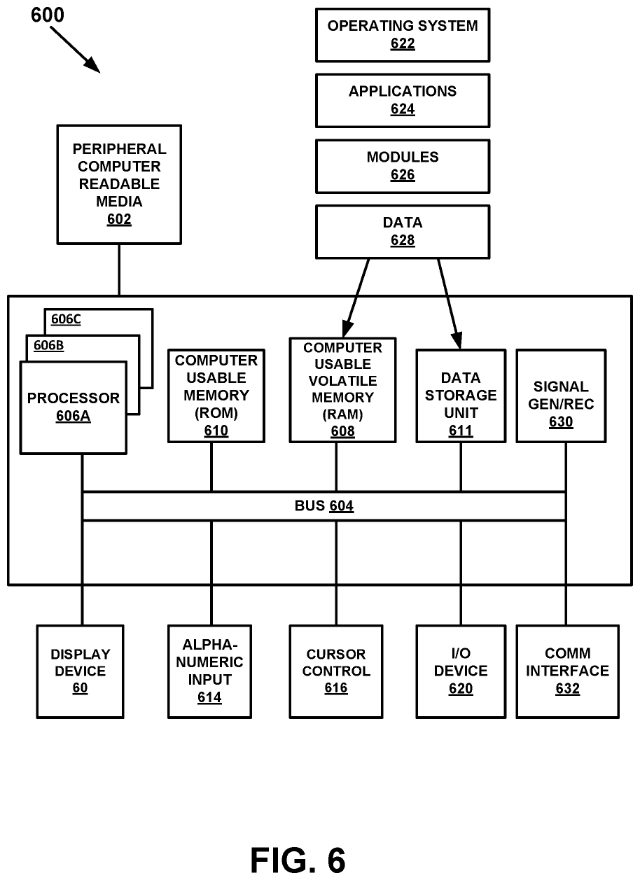

Consortium 101 is a computing system similar to the computing system described in FIG. 6. Consortium 101 can be a single machine, a virtual machine, a distributed system, a plurality of machines, or the like. In one embodiment, transactional data evaluator 110 is a component of the computing system utilized by consortium 101. In another embodiment, transactional data evaluator 110 is a completely distinct computing system (similar to the computing system described in FIG. 6) separate from consortium 101 and communicates with consortium 101 over a network such as network 124.

In one embodiment, the data received by consortium 101 is stored at database 112. In general, database 112 could be in the same location as consortium 101, remote from consortium 101, or the like. Moreover, database 112 could be in a single database or in a plurality of databases. The plurality of databases could be in a single location or in a plurality of locations including remote locations, virtual locations, and the like.

In operation, consortium 101 receives the customer transaction data from the one or more various information providers e.g., 102, 103, and 10n over a network 124 (such as the Internet, a secure network, local area network, and the like). Although there is no PII in the data received at consortium 101, consortium 101 can use information from the transactional data received from each of the various information providers (as described above) to develop a set of identified traits for each customer's transactional data.

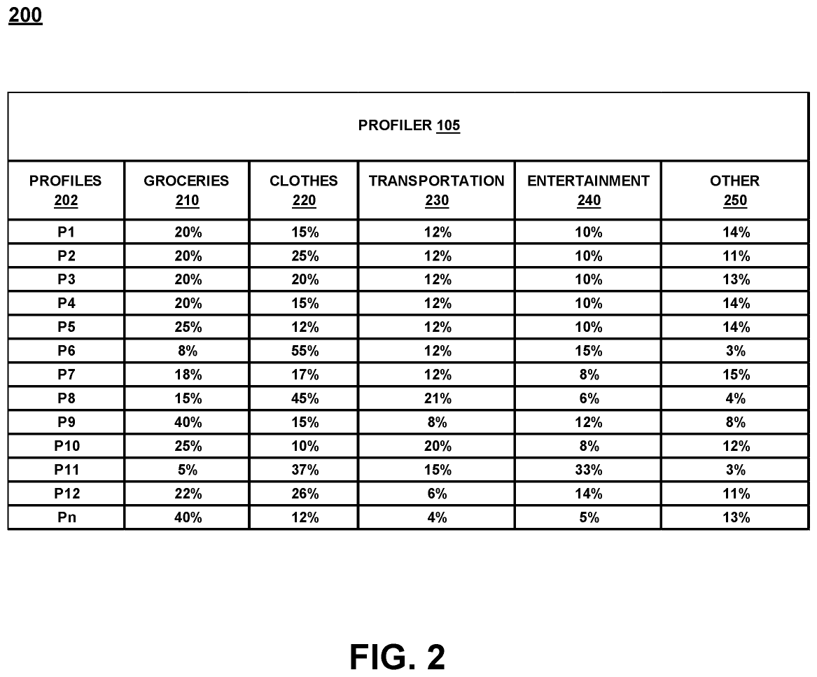

Referring now to FIG. 2 and to FIG. 1, a chart 200 representing a partial data set of aggregated customer transaction level data for a plurality of customer profiles 202 is shown in accordance with an embodiment. In one embodiment, chart 200 is a GUI prepared layout. In general, the plurality of non-PII customer transaction data is received from credit providers 102, 103, and 10n at consortium 101. Consortium 101 collects the customer transaction data and stores it in database 112. In one embodiment, profiler 105 accesses the database 112 to obtain the customer transaction data. In one embodiment, the customer transaction data is provided from consortium 101 to profiler 105.

Profiler 105 uses the information within each of the different sets of customer transaction data to place each different set of customer transaction data into a designated profile 202 (e.g., profile P1-Pn). In general, the number of profiles in chart 200 are exemplary. Profiler 105 could sort the customer transaction data into any number of different profiles. For example, there could be only two profiles (e.g., male and female; pet owner and non-pet owner; smoker and non-smoker; etc. In one embodiment, the number of profiles could be predefined, or could be based on a retailer's products. For example, there could be one or more profiles such as, but not limited to, male P1, female P2, other gender P3, smoker P4, alcohol purchaser P5, designer clothes purchaser P6, off-the-shelf clothes purchaser P7, luxury car owner P8, mass transit user P9, pet owner P10, age 17-25 P11, age 26-50 P12, age 51+ Pn, etc.

Although there are a number of profiles shown in chart 200, there could be more or less profiles. Further, the profiles could be different depending upon the retailer's product offerings. For example, a retailer that sells groceries may want one or more different profiles than a retailer that sells clothing. It should be appreciated that the customer transaction data would be applicable to a number of different profiles. In one embodiment, each identified profile would include any number of different customer transaction data sets. For example, the male P1 would likely include quite a few different customer transaction data sets. Similarly, a customer transaction data set can be included in a number of different identified profiles. For example, the age 26-50 P12 profile would likely include some customer transaction data sets that are also included in the male P1 profile.

In addition to sorting the different customer transaction data sets into the designated profiles 202, profiler 105 also provides a spending breakdown in a number of different categories. For example, chart 200 includes the categories: groceries 210, clothes 220, transportation 230, entertainment 240, and other 250. Although 5 categories are shown, it should be appreciated that there can be more or fewer categories. Moreover, there could be sub categories with the chart 200. For example, groceries could be broken down into categories such as, baby groceries, cleaning supplies, fruit and vegetables, drinks, flavor water, etc. Since the customer transaction data can be at the skew level, it may be possible to break down the purchases into any number of different categories.

Similarly, in chart 200 the results of the different categories is shown as a percentage of spending. In one embodiment, the percentage refers to the percentage of the total amount spent by the customer for a given time period (day, week, month, etc.), as indicated in the customer transaction data set. Although percentage of spending is shown, it is for purposes of clarity in the discussion. It should be appreciated that the information within the different category could be an averaged amount, or any other identification. For example, in chart 200, the female profile spends 20% on groceries 210, 15% on clothes 220, 12% on transportation, 10% on entertainment, 14% on other, etc. It should be realized that it is not necessary that the categories in each profile add up to 100%. It is not necessary that all of the profile's spending is shown in the different categories.

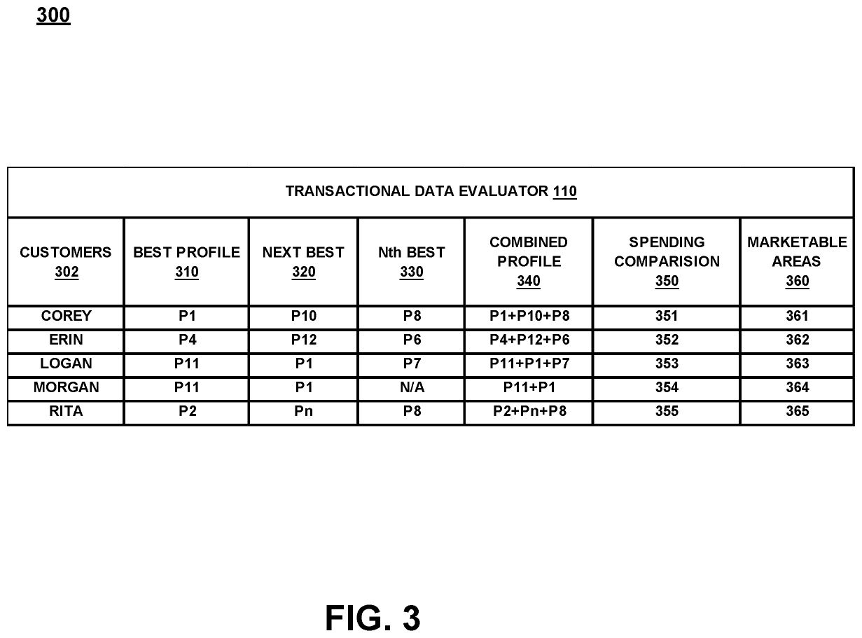

With reference now to FIG. 3, a chart 300 representing an evaluation of a partial data set of identified customers 302 in a retailer database 144 is provided by transactional data evaluator 110. In general, the partial data set contains a plurality of identified customers (e.g., Corey, Erin, Logan, Morgan, Rita). The identified customers 302 are sorted into their appropriate generic profiles previously discussed in FIG. 2. In one embodiment, chart 300 is a GUI prepared layout.

In general, a retailer database 144 refers to a database of records maintained by the retailer and associated with a plurality of identified customer's transactions. The transactions could be credit purchases, purchases associated with a rewards programs, or the like. Unlike the non-PII information received at consortium 101, the known PII transaction information will include the customer's identification information such as, name, address, phone number, family, birthday, etc. In addition to the PII, the information that could be included in the retailer's customer transaction data can be, but is not limited to, a transaction location (e.g., internet/in-store/address/store-identifier code, etc.), a transaction type (plastic card, digital wallet, etc.), a SKU (or other item identifier), a size, a description of the item(s) acquired during the transaction, etc.

As shown in chart 300, in one embodiment, the known customers 302 are sorted into their matching profiles. Although three profile levels are shown, it should be appreciated that the known customers 302 could be sorted into one or more generic profiles. In chart 300, the customers 302 are sorted into a best profile match 310, a next best profile match 320, and an Nth best profile match 330. Once the number of profiles is identified, the profiles are combined in combined profile 340.

In one embodiment, the combined profile is an equal average of any of the identified profiles. For example, customer Erin's combined profile would be generated as an equal average or the summation of each of the components of P4, P12, and P6 divided by three. (e.g., using clothes 220 of FIG. 2: (15%+26%+55%)/3 or 32%). In so doing, the combined profile 340 would be directly determined.

In another embodiment, each profile in the combined profile is weighted based on the best match, a retailer's identified profile importance, or the like. For example, customer Logan's combined profile would be generated as a 50% weight for P11, a 30% weight for P1 and a 20% weight for P7. In so doing, the combined profile 340 would be a hybrid and could add additional individuality to the resulting marketing strategy.

Once the combined profile 340 is determined, the spending comparison 350 is performed. The comparison could be a percentage, an actual amount, or the like. the comparison results 351-355 will be how each of the customer's actual spending compares with the generic profile spending. In other words, combining the plurality of customer transaction data sets into the different profiles will provide insight to a known customer's (e.g., Corey's) purchasing patterns that are presently visible in the retail database with what a generic customer with the same profile is spending. In so doing, the spending comparison 351 of Corey would allow a marketable areas 360 determination to be made. That is, the determination 361 as to where the spending of the actual customer Corey diverges from the spending of the underlying profile. Moreover, as additional customer transaction data sets are collected and assigned to each profile, the insight into the generic customer's spending can be further utilized in marketable area 361-365 to provide additional opportunities for rewards, offers, invitations, and the like that could be targeted toward the known customers 302.

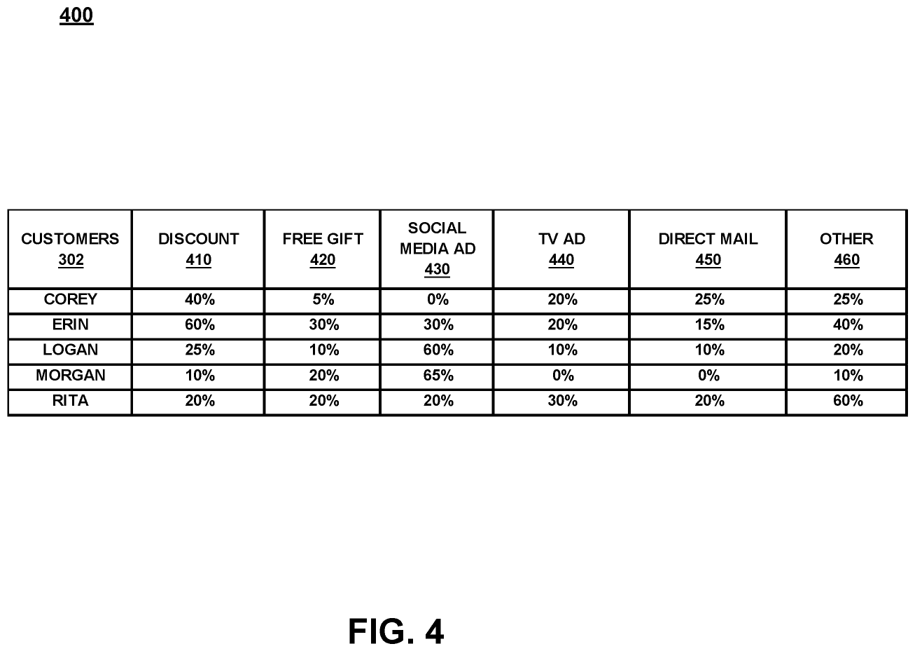

Referring now to FIG. 4, a chart 400 representing a partial data set from the retailer database, the partial data set containing a number of marketing evaluations for the plurality of profiled matched identified customers is shown in accordance with an embodiment. Although only 5 customers are represented, it should be appreciated that chart 400 could be generated for any, some, or all of the customers in the retail database 144. In one embodiment, chart 400 is a GUI prepared layout. Similarly, although a number of different advertising methods are shown, it should be appreciated that chart 400 could be generated for any, some, or a different advertising methods.

In general, the advertising methods include, but are not limited to, a discount 410, a free gift 420, a social media ad 430, a TV ad 440, a direct mail 450, and other 460. The percentages in each of the different advertising media columns reflect the percentage of time that the particular method was used by the known customers 302. For example, customer Rita made a purchase with a discount 20% of the time, a free gift 20% of the time, a social media ad 20% of the time, a TV ad 30% of the time, a direct mail 20% of the time, and other 60% of the time.

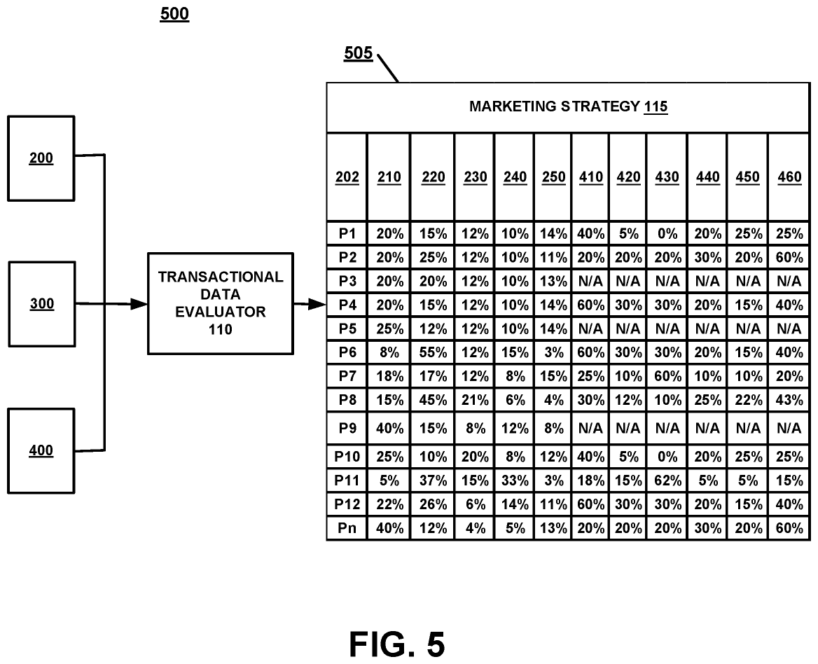

With reference now to FIG. 5 and to FIG. 1, a block diagram 500 of a method and system for combining the non-PII customer transaction data profile information chart 200 provided by the information providers to consortium 101 with the known customer profile sorting chart 300 and the marketing evaluation chart 400 using transactional data evaluator 110 to generate a chart 505 which is a partial marketing matrix, the partial marketing matrix containing a real-time continuously updateable working marketing strategies for customers as developed by the transactional data evaluator in accordance with an embodiment. As such, instead of being limited to the customer's purchasing patterns that are presently visible by a retailer, such as the retailer that populates retailer database 144, the transactional data evaluator 110 will use the combined data of marketing strategy 115 to provide insight into a customer's purchasing patterns across a spectrum of spending.

In other words, transactional data evaluator 110 will generate the marketing strategy 115, which contains quantified and specific information regarding generic profile metrics (210-250 of Chart 200) combined with known customer spending as profile sorted in chart 300 combined with the known marketing responsiveness of the known customers (as developed in chart 400) to ultimately build the marketing strategy 115 of chart 505. In one embodiment, marketing strategy 115 of chart 505 is provided in a visual format via GUI 60.

In one embodiment, information about marketing strategy 115 as developed by transactional data evaluator 110 will utilize the power of both known and unknown customer profiles to build a real-time, constantly updating marketing strategy that can be used to develop, guide, and grow both known customer specific purchasing behaviors and also develop marketing strategies that will be further tuned to provide the same guidance for an unknown customer. In one embodiment, marketing strategy 115can be shared with third parties such as, retailer partners and clients, via transactional data evaluator 110.

For example, utilizing the information from marketing strategy 115, a hybridized (specific and generic) customer's transaction habits/information/history can be presented via GUI 60 to a retailer to provide generic and specific customer purchasing insight. In one embodiment, one or more additional (or replacement, or different, or less) customer metrics can be provided by the transaction data evaluator 110 to one or more different retailers as a part of retail specific marketing strategy 115. Such different aspects can include channel shoppers, e.g., does the customer spend more shopping online or spend more shopping in a brick-and-mortar store. In one embodiment, the aspects can include a break down such as a percentage of transactions, for each of the plurality of customers, which occurred at a brick-and-mortar store, a break down such as a percentage of transactions, for each of the plurality of customers, that occurred online, and the like. Although percentage is discussed and charts are shown, it could also be presented in other formats such as spreadsheets, graphically, such as a pie chart, as a ratio, as a bar graph, etc.

Aspects of the marketing strategy 115 can also include the customer's spending level for brick-and-mortar spending, for online spending, or for the combination of both brick-and-mortar and online spending. In addition, by using one or more of the additional metrics, the customer profiles can be further identified as online or in-store shoppers. For example, generic customers that spend their retail dollars mostly online may be distinguished from generic customers that spend their retail dollars in brick-and-mortar stores. Thus, if the retailer wishes to focus on specific areas, e.g., online or brick-and-mortar store sales, the data can be so parsed.

In addition, since the information from charts 200-400 is updated at an adjustable and/or market driven timeframe, some or all of the marketing strategy 115 as shown in chart 505, could be updated hourly, daily, weekly, monthly, quarterly, semi-annually, and the like. Additionally, the transaction data evaluator 110 can continuously monitor, adjust, change, and/or refine marketing strategy 115 based on updates to one or more of the different customer categories, delivery vehicles, the occurrence of local or global events (e.g., a film festival, Superbowl, law change, societal feedback, etc.). Similarly, transaction data evaluator 110 will use the continual updates to adjust marketing strategy 115 to increase marketing aspects that work and reduce or stop marketing aspects that do not. Moreover, when a new customer with a similar profile as an existing customer is identified, marketing strategy 115 would indicate that the retailer should use the marketing lessons learned on customer Corey to guide the best form of marketing to the new customer.

### Example Computer System Environment

With reference now to FIG. 6, portions of the technology for providing a communication composed of computer-readable and computer-executable instructions that reside, for example, in non-transitory computer-readable storage media (e.g., non-transitory computer readable medium) of a computer system. That is, FIG. 6 illustrates one example of a type of computer that can be used to implement embodiments of the present technology. FIG. 6 represents a system or components that may be used in conjunction with aspects of the present technology. In one embodiment, some or all of the components described herein may be combined with some or all of the components of FIG. 6 to practice the present technology.

FIG. 6 illustrates an example computer system 600 used in accordance with embodiments of the present technology. It is appreciated that system 600 of FIG. 6 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 6, computer system 600 of FIG. 6 is well adapted to having peripheral computer readable media 602 such as, for example, a disk, a compact disc, a flash drive, and the like coupled thereto.

Computer system 600 of FIG. 6 includes an address/data/control bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors. Computer system 600 also includes data storage features such as a computer usable volatile memory 608, e.g., random access memory (RAM), coupled to bus 604 for storing information and instructions for processors 606A, 606B, and 606C.

System 600 also includes computer usable non-volatile memory 610, e.g., read only memory (ROM), coupled to bus 604 for storing static information and instructions for processors 606A, 606B, and 606C. Also present in system 600 is a data storage unit 611 (e.g., a magnetic disk drive, optical disk drive, solid state drive (SSD), and the like) coupled to bus 604 for storing information and instructions. Computer system 600 also includes an optional alpha-numeric input device 614 including alphanumeric and function keys coupled to bus 604 for communicating information and command selections to processor 606A or processors 606A, 606B, and 606C. Computer system 600 also includes an optional cursor control device 616 coupled to bus 604 for communicating user input information and command selections to processor 606A or processors 606A, 606B, and 606C. Optional cursor control device may be a touch sensor, gesture recognition device, and the like. Computer system 600 of the present embodiment also includes GUI 60 coupled to bus 604 for displaying information.

Referring still to FIG. 6, GUI 60 of FIG. 6 may be a liquid crystal device, cathode ray tube, OLED, plasma display device or other display device suitable for creating graphic images and alpha-numeric characters recognizable to a user. Optional cursor control device 616 allows the computer user to dynamically signal the movement of a visible symbol (cursor) on GUI 60. Many implementations of cursor control device 616 are known in the art including a trackball, mouse, touch pad, joystick, non-contact input, gesture recognition, voice commands, bio recognition, and the like. In addition, special keys on alpha-numeric input device 614 capable of signaling movement of a given direction or manner of displacement. Alternatively, it will be appreciated that a cursor can be directed and/or activated via input from alpha-numeric input device 614 using special keys and key sequence commands.

System 600 is also well suited to having a cursor directed by other means such as, for example, voice commands. Computer system 600 also includes an I/O device 620 for coupling system 600 with external entities. For example, in one embodiment, I/O device 620 is a modem for enabling wired or wireless communications between system 600 and an external network such as, but not limited to, the Internet or intranet. A more detailed discussion of the present technology is found below.

Referring still to FIG. 6, various other components are depicted for system 600. Specifically, when present, an operating system 622, applications 624, modules 626, and data 628 are shown as typically residing in one or some combination of computer usable volatile memory 608, e.g. random access memory (RAM), and data storage unit 611. However, it is appreciated that in some embodiments, operating system 622 may be stored in other locations such as on a network or on a flash drive; and that further, operating system 622 may be accessed from a remote location via, for example, a coupling to the internet. In one embodiment, the present technology, for example, is stored as an application 624 or module 626 in memory locations within RAM 608 and memory areas within data storage unit 611. The present technology may be applied to one or more elements of described system 600.

System 600 also includes one or more signal generating and receiving device(s) 630 coupled with bus 604 for enabling system 600 to interface with other electronic devices and computer systems. Signal generating and receiving device(s) 630 of the present embodiment may include wired serial adaptors, modems, and network adaptors, wireless modems, and wireless network adaptors, and other such communication technology. The signal generating and receiving device(s) 630 may work in conjunction with one or more communication interface(s) 632 for coupling information to and/or from system 600. Communication interface 632 may include a serial port, parallel port, Universal Serial Bus (USB), Ethernet port, Bluetooth, thunderbolt, near field communications port, WiFi, Cellular modem, or other input/output interface. Communication interface 632 may physically, electrically, optically, or wirelessly (e.g., via radio frequency) couple computer system 600 with another device, such as a mobile phone, radio, or computer system.

The computing system 600 is only one example of a suitable computing environment and is not intended to suggest any limitation as to the scope of use or functionality of the present technology. Neither should the computing environment be interpreted as having any dependency or requirement relating to any one or combination of components illustrated in the example computing system 600.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A system comprising:
a consortium to receive a first set of aggregated customer transaction data, the first set of aggregated customer transaction data having no personally identifiable information (PII) associated therewith;
a database to maintain a second set of aggregated customer transaction data for a second plurality of customers,
the second set of aggregated customer transaction data having PII associated therewith; and
a transactional data evaluator to:
use the first set of aggregated customer transaction data to develop a plurality of customer profiles;
compare the second set of aggregated customer transaction data with the plurality of customer profiles;
assign, based on the compare, each customer associated with the second set of aggregated customer transaction data to at least one of the plurality of customer profiles; and
generate, based on an evaluation of each customer associated with the second set of aggregated customer transaction data with respect to the assigned at least one of the plurality of customer profiles, a customer profile specific marketing strategy.

2. The system of claim 1 further comprising:
a graphic user interface (GUI) to provide the customer profile specific marketing strategy in a visual format.

3. The system of claim 1 wherein the first set of aggregated customer transaction data to develop a plurality of customer profiles is obtained from one or more purchases identified in the first set of aggregated customer transaction data.

4. The system of claim 3 wherein the one or more purchases identified in the first set of aggregated customer transaction data further comprise:
an identification of a specific purchase to include an item identification and a manufacturer identification; and
a determination of a characteristic of a buyer based on one or both of the item identification and the manufacturer identification.

5. The system of claim 1 wherein the plurality of customer profiles further comprise:
a percentage of transactions, for each of the plurality of customer profiles, that occurred at a brick-and-mortar store.

6. The system of claim 1 wherein the plurality of customer profiles further comprise:
a percentage of transactions, for each of the plurality of customer profiles, that occurred online.

7. The system of claim 1 wherein the transactional data evaluator is further to:
assign, based on the compare, each customer associated with the second set of aggregated customer transaction data to at least two of the plurality of customer profiles; and
develop a hybrid customer profile based on the combining of the at least two of the plurality of customer profiles.

8. A method comprising:
receiving a first set of aggregated customer transaction data, the first set of aggregated customer transaction data having no personally identifiable information (PII) associated therewith;
receiving a second set of aggregated customer transaction data for a second plurality of customers, the second set of aggregated customer transaction data having PII associated therewith; and
using the first set of aggregated customer transaction data to develop a plurality of customer profiles;
comparing the second set of aggregated customer transaction data with the plurality of customer profiles;
assigning, based on a result of the comparing, each customer associated with the second set of aggregated customer transaction data to at least one of the plurality of customer profiles; and
generating, based on an evaluation of each customer associated with the second set of aggregated customer transaction data with respect to the assigned at least one of the plurality of customer profiles, a customer profile specific marketing strategy.

9. The method of claim 8 further comprising:
presenting the customer profile specific marketing strategy in a visual format on a graphical user interface.

10. The method of claim 8 further comprising:
obtaining the plurality of customer profiles from one or more purchases identified in the first set of aggregated customer transaction data.

11. The method of claim 10 further comprising:
identifying a specific purchase to include an item identification and a manufacturer identification; and
determining a characteristic of a buyer based on one or both of the item identification and the manufacturer identification.

12. The method of claim 8 further comprising:
identifying a percentage of transactions, for each of the plurality of customer profiles, that occurred at a brick-and-mortar store.

13. The method of claim 8 further comprising:
identifying a percentage of transactions, for each of the plurality of customer profiles, that occurred online.

14. The method of claim 8 further comprising:
assigning, based on the result of the comparing, each customer associated with the second set of aggregated customer transaction data to at least two of the plurality of customer profiles; and
developing a hybrid customer profile based on the combining of the at least two of the plurality of customer profiles.

15. A non-transitory computer-readable medium storing instructions, the instructions comprising:
one or more instructions that, when executed by one or more processors, cause the one or more processors to:
receive a first set of aggregated customer transaction data, the first set of aggregated customer transaction data having no personally identifiable information (PII) associated therewith;
receive a second set of aggregated customer transaction data for a second plurality of customers, the second set of aggregated customer transaction data having PII associated therewith; and
use the first set of aggregated customer transaction data to develop a plurality of customer profiles;
compare the second set of aggregated customer transaction data with the plurality of customer profiles;
assign, based on the compare, each customer associated with the second set of aggregated customer transaction data to at least one of the plurality of customer profiles; and
generate, based on an evaluation of each customer associated with the second set of aggregated customer transaction data with respect to the assigned at least one of the plurality of customer profiles, a customer profile specific marketing strategy.

16. The non-transitory computer-readable medium of claim 15, where the one or more instructions, when executed by the one or more processors, further cause the one or more processors to:
provide the customer profile specific marketing strategy in a visual format on a graphical user interface.

17. The non-transitory computer-readable medium of claim 15, where the one or more instructions, when executed by the one or more processors, further cause the one or more processors to:
obtain the plurality of customer profiles from one or more purchases identified in the first set of aggregated customer transaction data.

18. The non-transitory computer-readable medium of claim 17, where the one or more instructions, when executed by the one or more processors, further cause the one or more processors to:
identify a specific purchase to include an item identification and a manufacturer identification; and
determine a characteristic of a buyer based on one or both of the item identification and the manufacturer identification.

19. The non-transitory computer-readable medium of claim 15, where the one or more instructions, when executed by the one or more processors, further cause the one or more processors to:
identify a percentage of transactions, for each of the plurality of customer profiles, that occurred at a brick-and-mortar store; and
identify a percentage of transactions, for each of the plurality of customer profiles, that occurred online.

20. The non-transitory computer-readable medium of claim 15, where the one or more instructions, when executed by the one or more processors, further cause the one or more processors to:
assign, based on the compare, each customer associated with the second set of aggregated customer transaction data to at least two of the plurality of customer profiles; and
develop a hybrid customer profile based on the combining of the at least two of the plurality of customer profiles.
